(19) United States
(12) Patent Application Publication
(10) Pub. No.: US 2008/0068971 A1
(43) Pub. Date: Mar. 20, 2008

(54) Optical pick-up apparatus and optical disc apparatus including the same

(76) Inventors: Akio Yabe, Fujisawa (JP); Toshio Sugiyama, Yokohama (JP); Daisuke Tomita, Yokohama (JP); Kazuhiro Todori, Yokohama (JP); Takashi Tayama, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/978,659

(22) Filed: Oct. 30, 2007

Related U.S. Application Data
(63) Continuation of application No. 11/671,536, filed on Feb. 6, 2007.

(30) Foreign Application Priority Data
Aug. 30, 2006 (JP) 2006-233042

(51) Int. Cl. G11B 7/00

(52) U.S. Cl. 369/112.01

(57) ABSTRACT

An optical pick-up apparatus having a plurality of light sources emitting light fluxes having different wavelengths from each other, an objective lens for focusing each of the light fluxes emitted from a plurality of light sources onto the information recording surface of the information recording medium, and an optical element reflecting a first light flux input from a predetermined direction, and a second light flux input from a different position in the direction of the optical axis of the objective lens in an inverse side to the side to which the first light flux is input, approximately in parallel to the direction of the optical axis of the objective lens.

### CROSS REFERENCE TO RELATED APPLICATION

This application is a continuation of U.S. application Ser. No. 11/671,536, filed Feb. 6, 2007, the contents of which are incorporated herein by reference. This application relates to U.S. Ser. No. ______, filed Oct. 30, 2007 and Ser. No. ______, filed Oct. 30, 2007, which are continuations of Ser. No. 11/671,536, filed Feb. 6, 2007.

### CLAIM OF PRIORITY

The present invention claims priority from Japanese application JP2006-233042 filed on Aug. 30, 2006, the content of which is hereby incorporated by reference into this application.

### BACKGROUND OF THE INVENTION

The present invention relates to an optical pick-up apparatus capable of recording and reproducing with respect to a plurality of optical discs, and an optical disc apparatus including the same.

There has been known a structure of a three-wavelength compatible pick-up which executes a recording or a reproduction with respect to a Blu-ray Disc (hereinafter, refer briefly to as BD), DVD and CD. structure which uses a violaceous laser having a wavelength of 407 nm for a first light source, uses a red laser having a wavelength of 655 nm for a second light source, and uses an infrared laser having a wavelength of 785 nm for a third light source. The structure is made such that a light flux emitted from these light sources is input to a three-wavelength compatible objective lens, and is focused on a recording and reproducing surface of each of information recording and reproducing mediums.

### SUMMARY OF THE INVENTION

However, JP-A-2005-293775 does not describe, for example, a case that the recording and/or the reproduction is executed with respect to HD-DVD (hereinafter, refer briefly to as HD).

In an optical pick-up capable of recording and reproducing plural kinds of information recording mediums having different recording and reproducing wavelengths, since used light sources and optical parts are increased, there is a problem that an entire outer shape is enlarged.

An object of the present invention is to provide a compact optical pick-up apparatus capable of executing at least one of a recording and a reproduction with respect to a plurality of information recording and reproducing mediums, and an optical disc apparatus including the same.

In order to achieve the object mentioned above, an optical pick-up apparatus in accordance with an aspect of the present invention is structured such as to be provided with a plurality of light sources, an objective lens for focusing a light flux emitted from a plurality of light sources onto an information recording surface of an information recording medium, and an optical element reflecting a first light flux emitted from any one of a plurality of light sources so as to be input from a predetermined direction, and a second light flux input from a different position in a direction of an optical axis of the objective lens in a reverse side to the side to which the first light flux is input, approximately in parallel to the direction of the optical axis of the objective lens.

In accordance with an aspect of the present invention, it is possible to achieve a compact optical pick-up apparatus which can record or reproduce a plurality of information recording mediums having different wavelengths of the recording or reproducing light.

Other objects, features and advantages of the invention will become apparent from the following description of the embodiments of the invention taken in conjunction with the accompanying drawings.

### BRIEF DESCRIPTION OF THE DRAWING

FIG. 1 is a conceptual view showing a horizontal cross section of a first embodiment;

FIG. 2 is a top elevational view of the first embodiment;

FIG. 3 is a conceptual view of a detailed cross section near a first light source 20 in accordance with the first embodiment;

FIG. 4 is a detailed view of a liquid crystal device 11 with a diffraction grating in accordance with the first embodiment;

FIG. 5 is a conceptual view showing a horizontal cross section of a second embodiment;

FIG. 6 is a view of a reference example of an optical system in correspondence to first to fourth information recording and reproducing mediums;

FIG. 7 is a detailed view of a reflection prism; and

FIG. 8 is a conceptual view of a system control.

### DETAILED DESCRIPTION OF THE INVENTION

A description will be given below of embodiments of an optical pick-up apparatus in accordance with the present invention. However, the embodiments in accordance with the present invention are not limited to them.

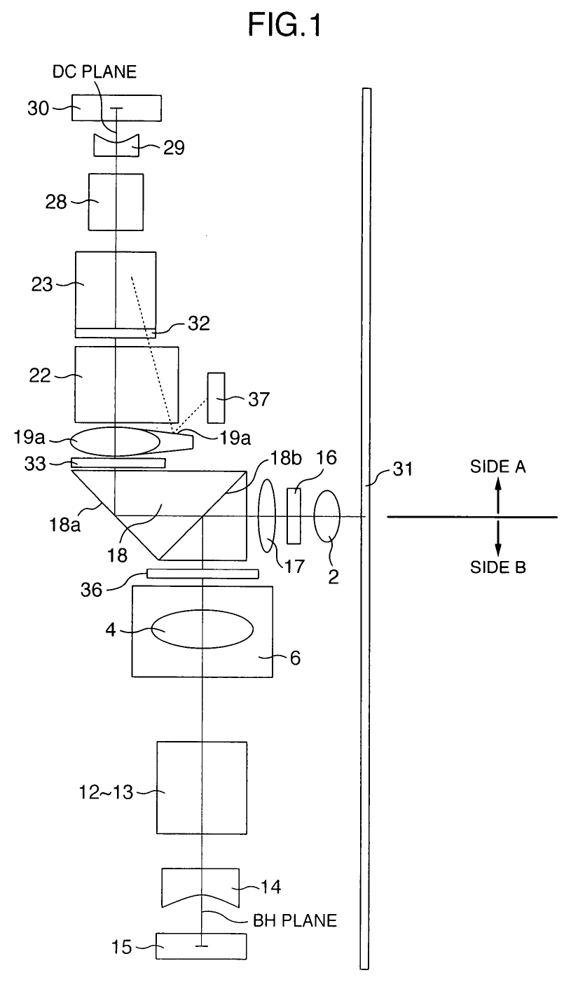

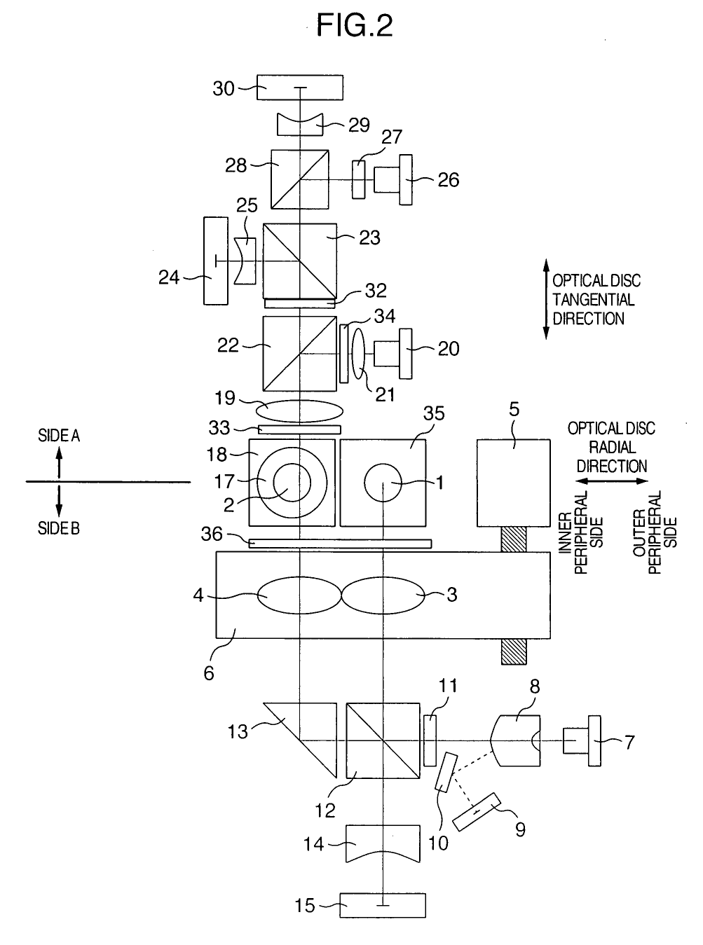

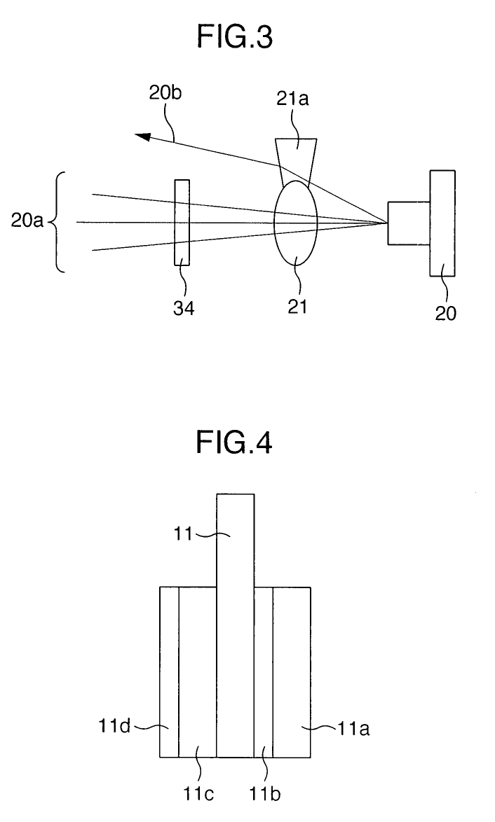

FIG. 1 is a conceptual view showing a horizontal cross section of an optical system of a first embodiment of an optical pick-up apparatus in accordance with the present invention. FIG. 2 is a view of the optical system of the optical pick-up shown in FIG. 1 as seen from a right side of a paper surface. FIG. 3 shows a conceptual view of a detailed cross section near a first light source 20 in accordance with the first embodiment. FIG. 4 shows a detailed view of a liquid crystal device 11 in accordance with the first embodiment.

In FIGS. 2 and 3, the first light source 20 is constituted by an infrared laser for CD having a wavelength of 785 nm. Of course, it is sufficient that the wavelength is close to 785 nm, and the wavelength is not limited to 785 nm. A light flux emitted from the first light source 20 passes through an auxiliary lens 21, and is divided into a zero-order light and ± primary lights by a CD diffraction grating 34. The CD diffraction grating 34 is rotationally adjusted in such a manner that the diffracted ± primary lights are irradiated to a track of the information recording and reproducing medium at a suitable angle.

The light flux passing through the CD diffraction grating 34 is reflected by a wavelength selective PBS prism 22. Further, the reflected light flux passes through a CP lens 19, passes through a quarter wave plate 33, and is converted into a circular polarized light. Thereafter, the circular polarized light is reflected by a first reflection surface 18a of a reflection prism 18, and changes its direction to a direction of an optical disc 31. Thereafter, it passes through a second reflection surface 18b having a wavelength selectiveness, passes through a CP lens 17, becomes a desired divergence degree with respect to a compatible objective lens 2, and passes through a wavelength selective opening limiting element 16, and only the opening limited light flux is input to the compatible objective lens 2, and is focused on an information recording and reproducing surface of the optical disc 31. In this case, the CP lens 19 and the CP lens 17 construct a relay lens achieving a desired magnification by two lenses.

The light flux reflected by the information recording and reproducing surface of the optical disc 31 is returned to the quarter wave plate 33, and again passes through the quarter wave plate, thereby being converted into a linear polarized light orthogonal to an outgoing light, and passing through the wavelength selective PBS prism 22. Thereafter, the polarized light is changed at 90 degree by a wavelength selective half wave plate 32, is reflected by a wavelength selective PBS prism 23, passes through a CD detecting lens 25, and is focused to a CD light receiving element 24, and a necessary signal is detected by the CD light receiving element 24.

It is possible to adjust a polarized state after passing by suitably setting a mounting angle of the wavelength selective half wave plate 32, and it is possible to adjust an amount of reflected light in the wavelength selective PBS prism 23. As a result, it is possible to adjust an amount of the outgoing light to the light receiving element 24, and it is possible to adjust a level of a CD system signal.

The signal obtained by the CD light receiving element 24 is processed by a signal processing portion 81 shown in FIG. 8, a reproduction signal is obtained at a time of reproducing, the compatible objective lens 2 forms focus controlled and tracking controlled signals by a servo signal forming portion 82 and is input to an AF-TR control circuit 83, and an auto focus (AF) control and a tracking (TR) control are executed. Further, a tilt drive signal is formed by a tilt signal forming portion 84, a tilt current is applied to a tilt coil via a tile drive circuit 85, and a movable portion including the compatible objective lens 2 executes a tilt operation.

These system controls are executed, and the systems are controlled in such a manner that a best optical characteristic can be obtained.

Although an illustration is omitted, an objective lens drive apparatus mounted on the compatible pick-up mentioned above is generally constituted by a three-dimensional objective lens driving apparatus executing an AF operation, a TR operation and a TILT operation. An AF coil, a TR coil and a TILT coil are arranged in the movable portion including the objective lens. The movable portion is supported to a fixed portion constructed by a magnet, a yoke and the like by six conductive elastic support members, and the system control mentioned above can be executed.

Generally, in the compatible objective lens 2, it is necessary to change a divergence/convergence degree of an outgoing light to the compatible objective lens 2 in correspondence to the information recording and reproducing medium, for example, input a divergence light in the case of corresponding to the CD, input a convergence light in the case of corresponding to the DVD, and the like. On the contrary, since the light flux directed to the light receiving element is different in the divergence/convergence degree, an additional optical element (for example, a wavelength selective liquid crystal lens) is necessary for the CD system or the DVD system in order to receive the light by the same light receiving element, and it is possible to read the signal by the same light receiving element on the basis of the additional element. However, the additional optical element generally has a bad efficiency for light utilization, and there is a disadvantage that an amount of light emitted from the compatible objective lens 2 becomes smaller.

In the present invention, as shown in FIG. 2, since the light receiving element 24 dedicated for the CD is arranged, and is set as an independent system from the DVD system, there is no problem that the amount of the outgoing light from the compatible objective lens 2 becomes smaller as mentioned above, and it is possible to structure an optical pick-up having an improved efficiency for light utilization.

A part (a light flux out of an effective diameter of the objective lens) of the light flux emitted from the first light source 20 is refracted by a reflection surface 21a integrally formed with the auxiliary lens 21 as shown in FIG. 3. A forward monitoring light flux 20b in the refracted light flux from the first light source 20 is reflected by the wavelength selective PBS prism 22, is reflected by a reflection surface 19a of the CP lens 19, and is irradiated to a forward monitor 37.

An electric current approximately in proportion to an amount of received light is generated in the forward monitor 37, and the forward monitor 37 outputs a signal in correspondence to the amount of the received light as a voltage signal in accordance with an I-V conversion. It is possible to execute a power control of the first light source 20, on the basis of the output.

The second light source 26 is constituted by a DVD red laser having a wavelength of 660 nm. Of course, it is sufficient that the wavelength is close to 660 nm, and the wavelength is not limited to 660 nm.

The light flux emitted from the second light source 26 is divided into a zero-order light and ± primary lights by a DVD diffraction grating 27. The DVD diffraction grating 27 is rotatably adjusted in the same manner as the CD diffraction grating 34, in such a manner that the diffracted ± primary lights are irradiated to the track of the information recording and reproducing medium at a suitable angle.

The light flux passing through the DVD diffraction grating 27 is reflected by the PBS prism 28, passes through the wavelength selective PBS prism 23, passes through the wavelength selective PBS prism 22, passes through the CP lens 19, and passes through the quarter wave plate 33, thereby being converted into a circular polarized light from a linear polarized light. The light flux converted into the circular polarized light is input to the reflection prism 18, is reflected by the same first reflection surface 18a by which the light flux emitted from the first light source 20 is reflected, changes its angle, and goes to a direction of an optical axis of the compatible objective lens 2. Thereafter, it passes through the wavelength selective second reflection surface 18b, passes through the CP lens 17, forms a desired convergence degree with respect to the compatible objective lens 2, passes through the wavelength selective opening limit element 16, is input to the compatible objective lens 2, and is focused on the information recording and reproducing surface of the optical disc 31.

In this case, the wavelength selective opening limit element 16 corresponds to an element achieving an opening limit function with respect only to a wavelength λ1 of the first light source 20, and does not limit the opening with respect to a wavelength λ2 of the second light source 26 so as to serve only as a glass plate. Further, the CP lens 19 and the CP lens 17 construct a relay lens achieving a desired magnification by two lenses in the same manner as described above.

The light flux reflected by the information recording and reproducing surface of the optical disc 31 is returned to the quarter wave plate 33, is converted into a linear polarized light orthogonal to the outgoing light by again passing through the quarter wave plate, and passes through the wavelength selective PBS prism 22 and the wavelength selective PBS prism 23. Thereafter, it passes through the PBS prism 28, passes through a DVD detecting lens 29, and is focused to a DVD light receiving element 30, and a necessary signal is detected by the DVD light receiving element 30.

The signal obtained by the DVD light receiving element 30 is processed by a signal processing portion 81 shown in FIG. 8 in the same manner as the signal obtained by the CD light receiving element 24 mentioned above. Further, a system control for recording and reproducing the DVD is the same as the system control of the CD mentioned above, and a detailed description thereof will be omitted.

On the other hand, a part of the light flux emitted from the second light source 26 is reflected by the PBS prism 28, passes through the wavelength selective PBS prism 23 and the wavelength selective PBS prism 22, is reflected by the reflection surface 19a of the CP lens 19, and is input to the forward monitor 37.

An electric current approximately in parallel to the amount of the received light is generated in the forward monitor 37, and a signal corresponding to the mount of the received light is output as a voltage signal in accordance with an I-V conversion. It is possible to execute a power control of the second light source 26 on the basis of this output.

A third light source 7 is constituted by a blue-violet laser having a wavelength of 405 nm. Of course, it is preferable that the wavelength is close to 405 nm, and the wavelength is not limited to 405 nm. The light flux emitted from the third light source 7 is beam shaped by a beam shaping element 8, and passes through a liquid crystal element 11 integrally formed with the diffraction grating. At this time, as shown in FIG. 4, it is possible to switch whether passing the linear polarized light emitted from the third light source without changing or passing after rotating the polarized light at 90 degree by a polarized light switching element 11c of the liquid crystal element 11 by applying a desired voltage to the polarized light switching element 11c.

Further, a diffraction grating 11d is arranged in front of the polarized light switching element 11c. It is possible to diffract into the 0-point light and the ± primary lights by passing through the diffraction grating. An attenuator element 11a capable of rotating the polarized light of the light flux emitted from the third light source 7 at a desired angle is arranged in the third light source 7 side of the liquid crystal element 11, and a polarized light diffraction grating 11b bouncing off only a predetermined polarized light component on the basis of the diffraction so as to reduce an amount of the passing light is arranged in front thereof.

In this case, for example, there is assumed a case of reproducing a third information recording and reproducing medium (which means HD-DVD here and is hereinafter described as HD) or a fourth information recording and reproducing medium (which means Blu-ray-Disc here and is hereinafter described as BD) by using the light flux emitted from the third light source 7.

In this case, in the blue-violet laser of the third light source 7, unless it emits light at 5 mW or more, a laser noise is generally enlarged, and there is a risk that a signal reproduction quality is lowered. Accordingly, at a time of reproducing, the linear polarized light emitted from the third light source 7 is rotated at a desired angle by the attenuator element 11a. For example, the polarized light of the light flux of the P polarized light is rotated, thereby forming an oval polarized light in which an S polarized light component is 80% and a P polarized light component is 20%. Next, only the S polarized light component is diffracted by the polarized light diffraction grating 11b. As a result, the light going straight through the polarized light diffraction grating 11b is constituted only by the P polarized light component which is about 20% of the total light amount emitted from the third light source 7.

In accordance with the function mentioned above, as a result, the amount of the emitted light of the third light source 7 is set to be equal to or more than 5 mW at a time of reproducing, and it is possible to suppress the laser noise. At a time of recording, a desired voltage is applied to the attenuator element 11a so as to set to a state in which the function of the polarized light rotation is not used, and the attenuator element 11a is operated while improving an efficiency.

In the description of the first embodiment, the attenuator function is achieved by using the liquid crystal element as shown in FIG. 4, however, the attenuator function may be achieved by employing a structure of mechanically counterchanging, for example, while using one dimmer filter and one transparent glass plate.

Specifically, the dimmer filter and the transparent glass are attached to a predetermined position of a rotor rotating on the basis of an electromagnetic force, and the dimmer filter and the transparent glass are counterchanged within an optical path by rotating the rotor, whereby the attenuator function shown in FIG. 4 can be achieved. Further, it goes without saying that the mechanism capable of achieving the same function can be structured on the basis of a linear motion in place of the rotational motion.

Next, a description will be given of the counterchange between the HD and the BD. The PBS prism 12 shown in FIG. 2 is an optical element executing the reflection or the transmission by the polarized light. Further, in the case of the BD, it is necessary to pass through the optical path to the objective lens 1, and in the case of the HD, it is necessary to pass through the optical path to the compatible objective lens 2. Accordingly, for example, in the case corresponding to the BD, the polarized light of the transmitting light flux is changed to the S polarized light by the polarized light switching element 11c of the liquid crystal element 11 as shown in FIG. 4. The light flux transmitting the liquid crystal element 11 in accordance with the S polarized light is reflected by the PBS prism 12, and passes through the optical path to the objective lens 1 for the BD. On the other hand, in the case corresponding to the HD, the polarized light of the transmitting light flux is changed to the P polarized light by the polarized light switching element 11c. The light flux transmitting the liquid crystal element 11 in accordance with the P polarized light transmits the PBS prism 12, and passes through the optical path to the compatible objective lens 2.

The structure is made such as to change the optical paths of the HD and the BD, as mentioned above.

In this case, the polarized light switching function is achieved by using the liquid crystal element as shown in FIG. 4, however, this function may be achieved, for example, by a structure of mechanically counterchanging by using one half wave plate, one transparent glass plate and the like.

Specifically, the polarized light switching function shown in FIG. 4 can be achieved by attaching the half wave plate and the transparent glass to predetermined positions of a rotor rotating by an electromagnetic force and rotating them so as to counterchange the half wave plate and the transparent glass within the optical path. Further, it is possible to structure by a mechanism on the basis of the linear motion in place of the rotational operation.

The description of the case corresponding to the BD will be continued. The light flux transmitting the polarized light switching element 11c on the basis of the polarized light for the BD in the polarized light switching element 11c is divided into the 0-point light and the ± primary lights by the diffraction grating 11d. The diffraction grating 11d is rotationally adjusted in a whole of the liquid crystal element 11 in such a manner that the diffracted ± primary lights are irradiated to the track of the information recording and reproducing medium at a suitable angle.

The light flux transmitting the diffraction grating 11d is reflected by the PBS prism 12, and transmits the CP lens 3. The CP lens 3 is integrally formed by the CP lens 4 for the HD and the holder 6, and is movable in the direction of the optical axis by the motor 5. A stepping motor, a piezoelectric element or the like is used in the motor 5, however, the motor 5 is not limited to them.

Further, in FIG. 2, the CP lens 3 and the CP lens 4 for the HD are arranged on the same plane, however, in order to make an interval between the optical axis of the HD system and the optical axis of the BD system small, the structure may be made such that the interval between the HD optical axis and the BD optical axis is reduced by moving forward and backward the CP lens 3 and the CP lens 4 for the HD so as to optically overlap a non-effective portion.

The light flux transmitting the CP lens 3 transmits the quarter wave plate 36 so as to be formed as a circular polarized light. Further, it is reflected in the same direction as the optical axis of the objective lens 1 arranged in a radial direction (in an outer peripheral side) of the information recording and reproducing medium with respect to the compatible objective lens 2, by a rising mirror 35. Thereafter, it is input to the objective lens 1, and is focused on the information recording and reproducing surface of the optical disc 31 by the objective lens 1. In this case, the quarter wave plate 36 is arranged between the holder 6 and the rising mirror 35, however, may be arranged between the holder 6 and the PBS prism 12.

At this time, it is possible to compensate a spherical aberration of the light flux emitted from the objective lens 1 by driving the CP lens 3 in the direction of the optical axis by the motor 5, and it is possible to obtain an improved optical characteristic.

The light flux reflected by the information recording and reproducing surface of the optical disc 31 is returned to the quarter wave plate 36, is converted into the linear polarized light orthogonal to the outgoing light by again transmitting the quarter wave plate, transmits the PBS prism 12, transmits the detection lens 14, is focused to the light receiving element 15, and detects a necessary BD signal by the light receiving element 15.

The BD reproduction signal is obtained at a time of the BD reproduction by using the signal obtained by the light receiving element 15, a focus control, a tracking control and a tilt control are applied to the objective lens 1, and the objective lens 1 is controlled by a system shown in FIG. 8 in such a manner that a proper optical characteristic can be obtained.

On the other hand, a part of the light flux emitted from the third light source 7 is reflected by an FM mirror 10, and is input to the forward monitor 9.

An electric current which is approximately in proportion to the amount of the received light is generated in the forward monitor 9, and the signal corresponding to the amount of the received light is output as a voltage signal in accordance with the I-V conversion. It is possible to execute a power control of the third light source 7 on the basis of the output.

Next, a description will be given of the case corresponding to the HD. The light flux transmitting the polarized light switching element 11c in accordance with the polarized light for the HD by the polarized light switching element 11c is divided into the zero-order light and the ± primary lights by the diffraction grating 11d. The diffraction grating 11d is rotationally adjusted suitable with respect to the disc for the BD as mentioned above. Accordingly, in the disc for the HD in which the track pitch is different from the disc for the BD, the diffracted ± primary lights are irradiated at an improper position to the track.

However, in the present embodiment, an optical magnification of the HD system is suitably set in correspondence to a ratio of the track pitch with respect to an optical magnification of the BD system, and the structure is made such that the ± primary lights are irradiated to the disc for the HD at a right position.

The diffraction grating 11d may be constituted by three divided diffraction gratings.

The light flux transmitting the diffraction grating 11d transmits the PBS prism 12, is reflected by the reflection prism 13, passes through the optical system for the HD which is approximately in parallel to the optical system for the BD, and transmits the CP lens 4. The CP lens 4 is structured such as to be adjustable in the direction of the optical axis by the motor 5 as mentioned above.

The light flux transmitting the CP lens 4 transmits the quarter wave plate 36, is formed as a circular polarized light, is input to the rising prism 18, is reflected in the same direction as the optical axis of the compatible objective lens 2 by the second reflection surface 18b as shown in FIG. 1, transmits the CP lens 17, achieves a desired convergence magnification, transmits the wavelength selective opening limit element 16, is input to the compatible objective lens 2, and is focused to the information recording and reproducing surface of the optical disc 31 by the compatible objective lens 2. In this case, the quarter wave plate 36 is arranged between the holder 6 and the rising mirror 18, however, may be arranged between the holder 6 and the reflection prism 13.

The wavelength selective opening limit element 16 corresponds to an element achieving the opening limit function only with respect to the first light source 20, and serves only as a glass with respect to the third light source.

In this case, a double refraction canceller function of canceling an influence of a double refraction of the optical disc 31 may be added to the wavelength selective opening limit element 16.

A position of the second reflection surface 18b within the reflection prism 18 is different from the first reflection surface 18a in the direction of the optical axis of the compatible objective lens 2, and is structured as a so-called two-story construction. In other words, the reflection prism 18 has two reflection surfaces comprising a first reflection surface 18a and a second reflection surface 18b, is shifted in the direction of the optical axis of the objective lens, and can reflect each of the light fluxes input from the reverse directions to each other in a direction which is in parallel to the optical axis of the compatible objective lens. The light flux for the CD or the DVD and the light flux for the HD input to the reflection prism 18 are shifted in the direction of the optical axis of the objective lens, and the input directions of the light fluxes are in the reverse directions to each other, however, the reflection prism 18 can reflect both of the respective light fluxes in the direction which is in parallel to the optical axis of the objective lens.

The CP lens 4 can compensate the spherical aberration of the light flux emitted from the compatible objective lens 2 by being driven in the direction of the optical axis by the motor 5, in the same manner as the case of the BD. Accordingly, it is possible to obtain an improved optical characteristic.

The light flux reflected by the information recording and reproducing surface of the optical disc 31 is returned to the quarter wave plate 36, and is converted into the liner polarized light orthogonal to the outgoing light by again transmitting the quarter wave plate. Further, it is reflected by the PBS prism 12, transmits the detection lens 14, and is focused to the light receiving element 15, and a necessary HD signal is detected by the light receiving element 15.

The HD reproduction signal is obtained at a time of the HD reproduction by using the signal obtained by the light receiving element 15, a focus control, a tracking control and a tilt control are applied to the compatible objective lens 2, and the compatible objective lens 2 is controlled by a system shown in FIG. 8 in such a manner that a best optical characteristic can be obtained.

On the other hand, a part of the light flux emitted from the third light source 7 is reflected by the FM mirror 10 at time of corresponding to the HD, and is input to the forward monitor 9.

An electric current which is approximately in proportion to the amount of the received light is generated in the forward monitor 9, and the signal corresponding to the amount of the received light is output as a voltage signal in accordance with the I-V conversion. It is possible to execute a power control of the third light source 7 on the basis of the output.

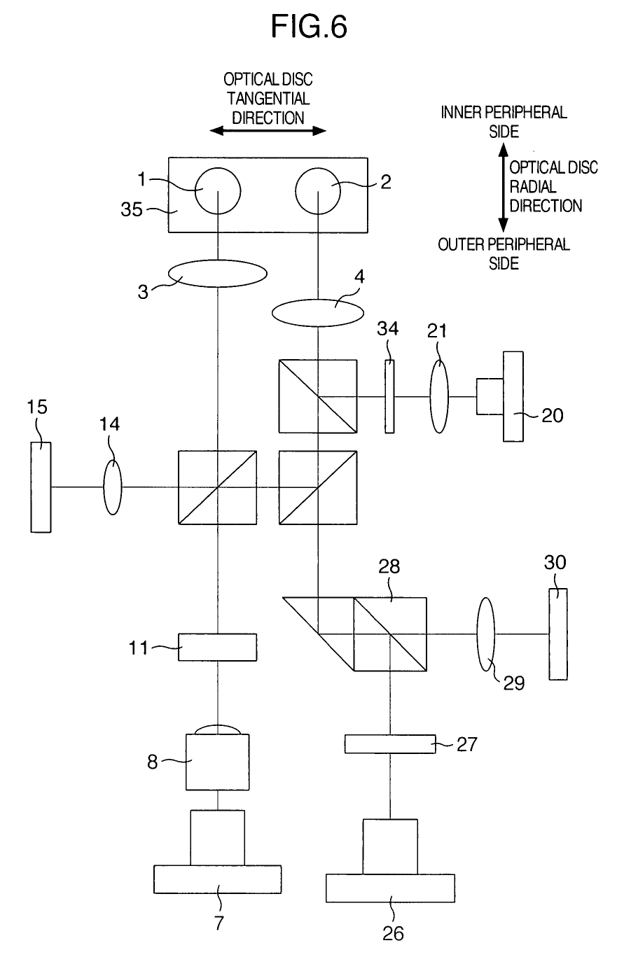

On the other hand, FIG. 6 shows a reference example of an optical system corresponding to first to fourth information recording and reproducing mediums. As shown in FIG. 6, as a method of combining the light flux from the third light source 7 and the light flux from the first light source 20 and the second light source.26 with the optical axis of the compatible objective lens 2, there is generally employed a method of executing by utilizing the prism within the same plane. In this case, an actual optical system is structured by arranging the rising mirror below the objective lens in addition to the combining prism. Accordingly, there is generated a necessity that a three-wavelength compatible optical system is arranged in the same direction (in an outer peripheral direction in FIG. 6) with respect to the compatible objective lens 2 as shown in FIG. 6, and a project area of an optical system layout with respect to the pick-up is enlarged. As a result, there is generated an enlargement of a whole of the information recording and reproducing apparatus.

However, in the present invention, as shown in the embodiment, the optical systems of the first light source 20 and the second light source 26 are arranged in a side of one direction (in a side of A shown in FIG. 1), and the optical system of the third light source 7 is arranged in a side of the other direction (a side of B shown in FIG. 1) with respect to the compatible objective lens 2. Further, the optical system of the third light source 7 is arranged on a different surface (a BH plane shown in FIG. 1) from a plane (a DC plane shown in FIG. 1) in which the optical systems of the first light source 20 and the second light source 26 are structured. Further, since the structure is made such as to focus each of the light fluxes comprising the light flux emitted from the third light source 7 and the light flux emitted from the first light source 20 and the second light source 26 in the inverse direction to the light flux by one compatible objective lens 2, by reflecting each of the light fluxes in the same direction at the different positions (18a and 18b) with respect to the direction of the optical axis of the compatible objective lens 2, the project area of the whole of the pick-up becomes small. As a result, it is possible to make a whole of the information recording and reproducing apparatus compact.

In the example shown in FIG. 1, the structure is made such as to arrange the first light source 20, the second light source 26 and the optical systems thereof in the side A, and arrange the third light source 7 and the optical system thereof in the side B, however, the structure may be made such as to arrange the third light source 7 and the optical system thereof in the side A, and arrange the first light source 20, the second light source 26 and the optical systems thereof in the side B.

In the first embodiment, the objective lens 1 and the compatible objective lens 2 are arranged in the radial direction of the optical disc as shown in FIG. 2, however, they may be arranged in a tangential direction of the optical disc. In the case of being arranged in the tangential direction of the optical disc, the structures of the reflection prism.18 and the rising mirror 35 are appropriately changed.

As a structure in which the objective lens 1 and the compatible objective lens 2 are arranged in the tangential direction of the optical disc, a description will be given, for example, of a case that the objective lens 1 and the compatible objective lens 2 are arranged in a vertical direction in FIG. 2. At this time, it is preferable to arrange the objective lens 1 in the side B and arrange the compatible objective lens 2 in the side A. In this case, the third light source 7 is arranged in such a manner that the light flux is emitted from a lower side toward an upper side, in FIG. 2. Further, an optical part conducting the light flux emitted from the third light source 7 to the objective lens 1 and the compatible objective lens 2 is arranged in a vertical direction in the drawing in the same manner. Further, the structure is made such that the optical path of the light flux emitted from the third light source 7 can be switched to two optical paths in a direction perpendicular to a paper surface of FIG. 2. The structure is made such as to input the light flux passing through the optical path in a near side of the paper surface of FIG. 2 to the reflection surface 18b of the reflection prism 18 at a time of recording or reproducing the HD. Further, the structure is made such as to reflect the light flux passing through the optical path in the near side of the paper surface by the rising mirror 35 so as to input to the objective lens 1, at a time of recording or reproducing the BD.

Further, the structure may be made such as to reflect the light flux emitted from the third light source 7 so as to input to the objective lens 1 at a time of recording or reproducing the BD, and transmit the light flux emitted from the third light source 7 so as to input to the reflection surface 18b of the reflection prism 18 at a time of recording or reproducing the HD, without employing the structure capable of switching the optical path of the light flux emitted from the third light source 7 to two optical paths in the direction perpendicular to the paper surface of FIG. 2. For example, the structure mentioned above can be achieved by combining the PBS prism switching the optical paths of the HD and the BD and the polarized light switching element, as mentioned above.

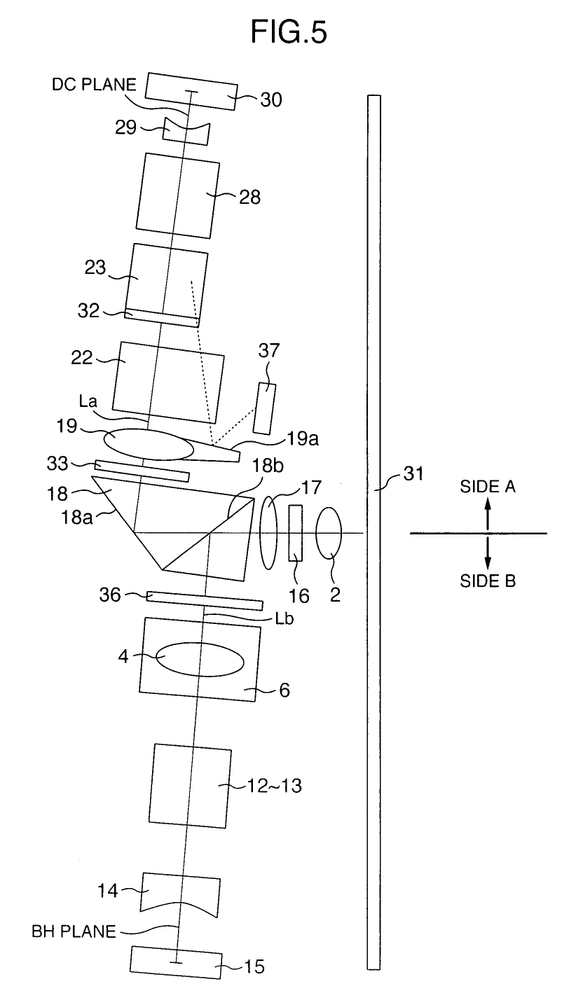

FIG. 5 shows a second embodiment in accordance with the present invention. In this case, a top elevational view of the second embodiment is approximately the same as the case of the first embodiment shown in FIG. 2. Further, the same reference numerals are attached to the same structure parts as those of the first embodiment, and a description thereof will be appropriately omitted.

In the first embodiment shown in FIG. 1, the first light source 20, the second light source 26 and the third light source 7 are arranged by the optical axis which is approximately in parallel to the information recording and reproducing surface of the optical disc 31. Specifically, the DC plane and the BH plane shown in FIG. 1 are arranged in the plane which is in parallel to the optical disc 31. In this case, if the respective parts are arranged actually, a dimension from the optical disc 31 to a bottom surface (an opposite surface to a light emitting side) of the optical pick-up becomes large. Particularly, holders for mounting are generally arranged in the first light source 20, the second light source 26 and the light receiving element 30 arranged on the DC plane, and the dimension (a height dimension) of the optical pick-up is enlarged at a degree of an outer shape of the holders. On the contrary, since the third light source 7 and the light receiving element 15 arranged on the BH plane are brought into contact with, for example, a shaft mounting the optical pick-up to a drive mechanism at a high possibility, it is desirable that these elements be arranged in the bottom surface side of the optical pick-up.

Accordingly, it is possible to more effectively make good use of the dimension in the height direction of the optical pick-up by inclining the optical system arranged on the DC plane as shown in FIG. 5 at about 3 degree in a clockwise direction with respect to the optical system having the structure shown in FIG. 1, and simultaneously inclining the optical system arranged on the BH plane at about 3 degree in a clockwise direction with respect to FIG. 1, and it is also possible to achieve a compactness in the height dimension. In other words, it is possible to more effectively make good use of the dimension in the height direction of the optical pick-up by structuring the optical pick-up in such a manner that the surface on the which optical system conducting the light flux emitted from the first light source 20 and the second light source 26 to the reflection prism 18 is arranged is inclined at about 3 degree with respect to the plane orthogonal to the optical axis of the compatible objective lens 2, and it is also possible to achieve the compactness in the height dimension.

It is preferable to determine the actually inclined angle, for example, in such a manner that the light receiving elements 15 and 30 are positioned near an approximately center of the height of the optical case (not shown) mounting the optical parts shown in FIG. 5. Accordingly, it is possible to achieve a compactness in the height direction of the optical pick-up. More specifically, it is preferable to set such that an angle θ of the input light with respect to the surface orthogonal to the optical axis of the compatible objective lens satisfies a relation 0<θ≦(H/L), in which a length of the optical system of the optical case and the optical pick-up is set to L, and a moving amount in the height direction of the optical case is set to H.

In the case of the present embodiment, since the length of the optical case is set to about 30 mm, and the moving amount in the height direction of the optical case is set to about 1.5 mm, this angel is about 3 degree. The paths of the light fluxes emitted from of the respective light sources are the same as the first embodiment.

In this case, an optical system input to the reflection prism 18 from each of the light sources is structured such that the light flux is input to the reflection prism 18 from a direction of an angle which is smaller or larger than 90 degree with respect to the optical axis of the compatible objective lens 2, in place of inputting the light source to the reflection prism 18 from the direction which is approximately orthogonal to the optical axis of the compatible objective lens 2. In the example shown in FIG. 5, the angles of two reflection surfaces 18a and 18b of the reflection prism 18 are set such that a light flux La input to the reflection prism 18 at an angle smaller than 90 degree with respect to the optical axis of the compatible objective lens 2, and a light flux Lb input at an angle larger than 90 degree are reflected in the same direction as the optical axis of the compatible objective lens 2.

In this case, an optical system (hereinafter, refer to as a CD-DVD optical system) is provided for conducting the light flux emitted from the first light source and the second light source to the reflection prism 18, and an optical system (hereinafter, refer to as a BD-HD optical system) is provided for conducting the light flux emitted from the third light source to the reflection prism 18 and the rising mirror 35. The CD-DVD optical system and the BD-HD optical system are not arranged within the same plane, but are arranged within different planes from each other. In other words, the two-story structure is formed. Further, a plane including the CD-DVD optical system and a plane including the BD-HD optical system are not in parallel, but an entire optical system is structured such that the reflection prism 18 is positioned between the CD-DVD optical system and the BD-HD optical system inclined at the predetermined angles.

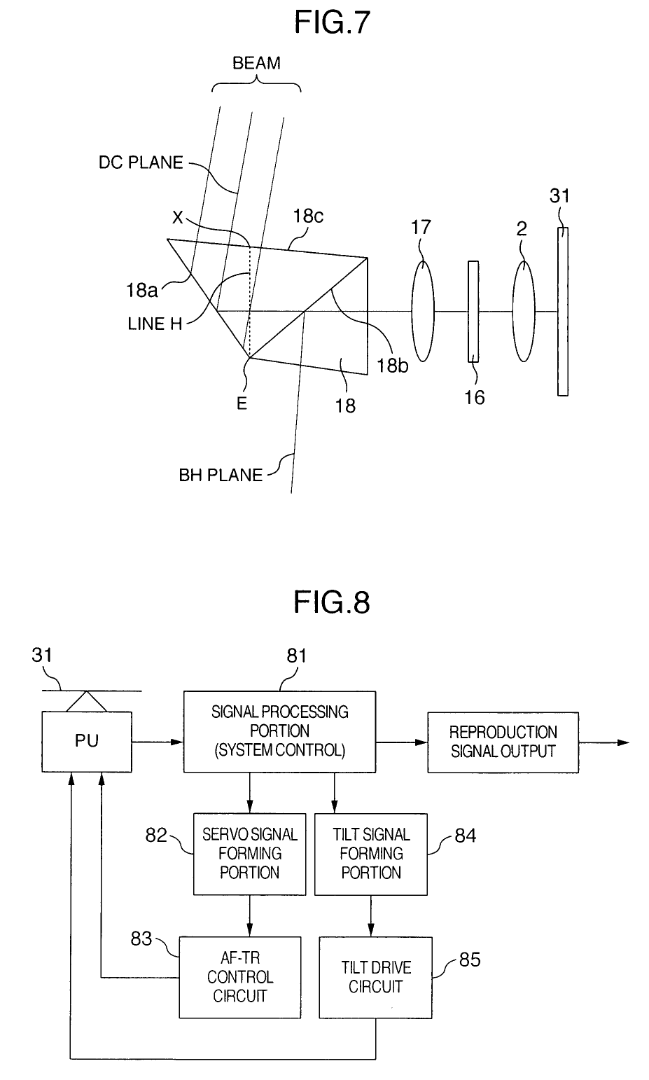

FIG. 7 shows a state around the reflection prism 18 in the second embodiment in detail. The light flux (BEAM) from the DC plane inclined at about 3 degree is input to an incident surface 18c of the reflection prism 18. At this time, the incident BEAM includes an intersecting point X between a straight line (line H) which is perpendicular to the optical axis of the compatible objective lens 2 and passes through a corner E of the first reflection surface 18a and the incident surface 18c. This is caused by the structure that the optical axis including the first to second light sources included in the DC plane is inclined at about 3 degree, and the compactness (thinness) of the height can be achieved on the basis of this structure.

In the second embodiment, since the structure is made, in the same manner as the first embodiment, such that the optical systems of the first light source 20 and the second light source 26 are arranged in one direction (the side A shown in FIG. 5) with respect to the compatible objective lens 2, the optical system of the third light source 7 is constructed in the different surface (the BH plane shown in FIG. 5) from the plan (the DC plane shown in FIG. 5) in which the optical systems of the first light source 20 and the second light source 26 in the other direction (the side B shown in FIG. 5) are constructed, with respect to the compatible objective lens 2, and the light flux emitted from the third light source 7 and the light flux emitted from the first light source 20 and the second light source 26 are reflected in the coaxial direction, at the different positions (18a and 18b) with respect to the direction of the optical axis of the compatible objective lens 2, the project area of the whole of the pick-up becomes small. As a result, it is possible to make a whole of the information recording and reproducing apparatus compact.

The objective lens 1 and the compatible objective lens 2 are also arranged in the radial direction of the optical disc as shown in FIG. 2 in the second embodiment, however, may be arranged in the tangential direction of the optical disc as mentioned in the first embodiment.

Further, in the case of the second embodiment, since the DC plane and the BH plane are inclined to the surface orthogonal to the optical axis of the objective lens 1 or the compatible objective lens 2, it is possible to achieve the compactness in the height direction of the optical pick-up. As a result, it is possible to achieve the thinness of a whole of the information recording and reproducing apparatus.

Further, it is desirable that the DC plane and the BH plane in the second embodiment shown in FIG. 5 be approximately in parallel to each other, whereby it is easy to manufacture the rising prism 18 and it is possible to achieve a cost reduction. Further, it is possible to make only the DC plane or the BH plane diagonal to the surface orthogonal to the optical axis of the objective lens, with respect to the surface orthogonal to the optical axis of the objective lens.

Further, in the first embodiment and the second embodiment, the description is given by setting two objective lenses to the BD dedicated lens (the objective lens 1) and the HD/DVD/CD three-wavelength compatible objective lens (the compatible objective lens 2), however, the combination of these two objective lenses may be set such that one is constituted by a BD and DVD compatible objective lens, and the other is constituted by an HD and CD compatible objective lens. In this case, it is necessary to change the optical system layout from the structure shown in FIG. 2.

For example, the optical system of the DVD system constructed by the second light source 26 is moved to the optical axis of the objective lens 1, and the rising mirror 35 is constructed by an optical element having approximately the same characteristic as the reflection prism 18, in FIG. 2. In accordance with this structure, it is possible to correspond to the combination of the BD and DVD compatible objective lens, and the HD and CD compatible objective lens.

Further, in the first embodiment and the second embodiment, the description is given of the structure in which the prism is mainly used as the optical element having a plurality of reflection surfaces reflecting the light flux emitted from the first light source and the second light source, and the light flux emitted from the third light source in approximately the same direction as the optical axis of the objective lens, however, the present invention is not limited to this, but the prism may be replaced by a mirror as far as a necessary film characteristic can be achieved.

Further, the prism having a plurality of reflection surfaces may be constituted by prisms divided per the reflection surfaces, and the divided prisms may be, of course, replaced by the mirrors having the necessary film characteristic.

As described above, in accordance with the present invention, it is possible to provide the compact and thin compatible optical pick-up apparatus which can execute the recording and/or the reproduction with respect to four kinds of information recording and reproducing mediums such as CD, DVD, HD and BD.

Further, since the light receiving elements dedicated for the CD and the DVD are arranged, it is possible to provide the compatible optical pick-up apparatus having an improved efficiency for light utilization.

The optical pick-up apparatus mentioned above is used by being installed to the optical disc apparatus. The optical disc apparatus processes the signal obtained by the optical pick-up apparatus so as to obtain the reproduction signal, and reproduces the information recorded on the information recording and reproducing medium rotated by the rotation driving mechanism such as the motor or the like. Further, the optical disc apparatus can irradiate the recording light into the information recording and reproducing medium from the optical pick-up apparatus so as to record the information on the information recording and reproducing medium.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. An optical disc apparatus comprising:
an optical pick-up apparatus executing at least one of recording and reproduction of information with respect to a plurality of information recording mediums in which wavelengths of laser lights for recording and reproducing are different from each other; and
a signal processing portion processing a signal obtained by the optical pick-up apparatus so as to output a reproduction signal,
wherein the optical pick-up apparatus comprises:
a plurality of light sources emitting light fluxes having different wavelengths from each other;
an objective lens focusing each of the light fluxes emitted from the plurality of light sources onto the information recording surface of the information recording medium; and
an optical element reflecting a first light flux input from a predetermined direction, and a second light flux input from a different position from the input position of the first light flux in the direction of the optical axis of the objective lens in an inverse side to the side to which the first light flux is input, approximately in parallel to the direction of the optical axis of the objective lens.
